(19) United States
(12) Patent Application Publication
(10) Pub. No.: US 2023/0195792 A1
(43) Pub. Date: Jun. 22, 2023

(54) DATABASE MANAGEMENT METHODS AND ASSOCIATED APPARATUS

(71) Applicant: INVIXO CONSULTING GROUP A/S, Søborg (DK)

(72) Inventors: Lars Hvam PETERSEN, Søborg (DK); Peter KREINER-SASADY, Søborg (DK); Ralph NEDERGAARD, Søborg (DK)

(21) Appl. No.: 17/926,944

(22) PCT Filed: May 19, 2021
(86) PCT No.: PCT/EP2021/063328

§ 371 Date: Nov. 21, 2022

(30) Foreign Application Priority Data
May 22, 2020 (DK) PA 2020 70332

(51) Int. Cl. G06F 16/901; G06F 16/907

(52) U.S. Cl. CPC G06F 16/9017; G06F 16/907

(57) ABSTRACT

A computer-implemented method for generating one or more REST webservices for providing access to database information in an SAP system. The method can comprise: receiving a user request to interact with the database information; querying a replica data model based on the user request, wherein the replica data model is representative of a database table structure of a database containing the database information; returning, in response to the querying, one or more identifiers of the database information based on the user request and the database table structure; and generating one or more REST webservices based on one or more selected identifiers. The REST webservices can be configured to: read the database information via an application layer in communication with the database and provide the database information as an open format message; or write the database information to the database.

### BACKGROUND

The present disclosure relates to apparatus, systems and methods for managing access to data stored in a database and, in particular, although not necessarily, to enabling reading and writing of database information.

### SUMMARY

According to a first aspect of the invention, there is provided a computer-implemented method for generating one or more REST webservices for providing access to database information in an SAP system, the method comprising:
receiving a user request to interact with the database information;
querying a replica data model based on the user request, wherein the replica data model is representative of a database table structure of a database containing the database information;
returning, in response to the querying, one or more identifiers of the database information based on the user request and the database table structure;
generating one or more REST webservices based on one or more selected identifiers, wherein the REST webservices are configured to:
   read the database information via an application layer in communication with the database and provide the database information as an open format message; or
   write the database information to the database.

Advantageously, such a method can enable a person that is not necessarily a technical expert in database coding to generate one or more REST webservices. Furthermore, use of the replica data model can advantageously provide a computationally convenient and efficient mechanism for allowing a user to generate a REST webservice that can interact with both standard and non-standard tables.

The SAP system is an example of an Enterprise Resource Planning (ERP) database system. One or more of the examples disclosed herein can work with ERP database systems which have the ability to expose REST OpenAPI services, but don't have a built-in framework to automatically generate services themselves.

The replica data model may be representative of an internal structure of tables of the database.

The replica data model may be representative of a subset of an internal structure of a table of the database.

The replica data model may be independent of the database information.

A table of the database represented in the replica data model may be a non-standard table.

The one or more identifiers may specify one or more tables of the database and/or one or more fields of one or more tables of the database.

The user request may be generated by an iterative process of interaction between a user and the replica data model.

The method may further comprise validating the one or more identifiers by communicating the generated REST webservice to the application layer to determine that it is consistent with a structure of the database.

Generating the one or more REST webservices may be performed in response to receiving one or more direct-identifiers directly from a use. The one or more direct-identifiers may be configured to identify database information stored in the database.

The method may further comprise using the REST webservice to read or write the database information via the application layer.

The method may further comprise using the REST webservice to provide the database information as the open format message.

The method may further comprise: validating the database table structure of the replica data model such that only valid identifiers can be presented to the user for selection, and therefore such that the user request does not represent any invalid identifiers.

According to a further aspect of the disclosure, there is provided an apparatus comprising:
a replica data model is representative of a database table structure of a database containing database information in an SAP system;
a user interface configured to:
   receive a user request to interact with database information;
   query the replica data model based on the user request;
   receive, in response to the query, one or more identifiers of the database information based on the user request and the database table structure; and
a processor configured to:
   generate one or more REST webservices based on the one or more selected identifiers, wherein the REST webservices are configured to:
      read the database information via an application layer in communication with the database and provide the database information as an open format message; or
      write the database information to the database.

There is also provided a computer-implemented method for generating one or more REST webservices for providing access to database information, the method comprising:
receiving a user request to interact with the database information;
querying a replica data model based on the user request, wherein the replica data model is representative of a database table structure of a database containing the database information;
returning, in response to the querying, one or more identifiers of the database information based on the user request and the database table structure;
generating one or more REST webservices based on the one or more identifiers, wherein the REST webservices are configured to:
   read the database information via an application layer in communication with the database and provide the database information as an open format message; or
   write the database information to the database.

There may be provided a computer program, which when run on a computer, causes the computer to configure any apparatus disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF DRAWINGS

One or more embodiments will now be described by way of example only with reference to the accompanying drawings in which:

FIG. 1 shows an example embodiment of a computing system for enabling access to a database, via an application layer, using a replica data model;

FIG. 2 shows an example of how the computing system of FIG. 1 can be used for accessing information in a database;

FIG. 3 shows another example of how the computing system of FIG. 1 can be used for enabling access to a database, via an application layer; and

FIG. 4 shows schematically two different ways in which a user can generate a REST webservice using a system described herein.

### DETAILED DESCRIPTION

A database may contain a vast amount of information which may be organised into hundreds of thousands, or millions, of different tables. For a user to access particular information in a database may therefore require complex computer coding tasks to be performed to produce scripts that are necessary for extracting the required information. This may render it difficult or impossible for many users to access the information in an efficient and timely way. Alternatively, a specialist developer may be required to write a bespoke script. Even then, the preparation of the necessary script can be extremely time consuming for the specialist developer. Therefore, there exists a need for improved methods for enabling users to access information in complex databases without requiring sophisticated and bespoke computer coding for every possible combination of data that a user may desire to access.

In the present disclosure, the term ‘database information’ is used to refer to any data, information, or content that can be stored in a database. This terminology does not imply any limitation to the cognitive content of the database information. The present disclosure relates to improved ways of providing access to such database information.

Here, providing access can refer to generating one or more REST webservices for: (i) reading database information from a database; and/or (ii) writing database information to a database. In some examples, this can be considered as controlling database information.

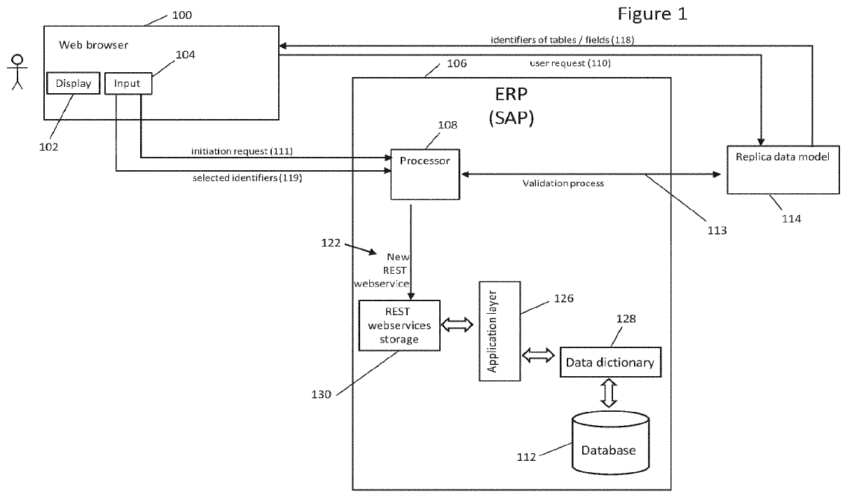

FIG. 1 shows a computer system for enabling access to database information that is stored in a database 112, which is part of a database system 106. In this example, a first user can use a web browser 100 to interact with a webpage that has: (i) a display 102; and (ii) input functionality 104 so that the user can provide input that is representative of database information that he or she wishes to access. As will be discussed in detail below, advantageously the system of FIG. 1 can enable a person that is not necessarily a technical expert in database coding to use the web browser 100 to generate one or more REST webservices. As is known in the art, use of a REST webservice ensures that data is communicated in an open format

It will be appreciated that in other examples a bespoke application, or any other interface, can be used by the first user to interact with the database system 106.

As shown in FIG. 1, the database system 106 is operatively coupled to the web browser 100, for example via the Internet. Examples of database systems 106 that may be used are provided by SAP (RTM), Oracle (RTM) and other vendors. In the example of FIG. 1, an SAP (RTM) database system 106 is used. The database system 106 has a processor 108, which can be referred to as a service generator.

FIG. 1 also includes a replica data model 114 that is representative of the structure of the database 112 that ultimately stores the desired database information. Further details of the replica data model 114 will be provided below.

The processor 108 can receive an initiation request 111 from the web browser 100, where the initiation request 111 represents an indication from the first user that they intend to generate one or more REST webservices for interacting with the database information.

In this example, the content of the replica data model 114 is validated such that only valid identifiers can be subsequently presented to the user on the display 102 of the web browser 100. The validation can be performed in response to the initiation request 111. The identifiers may specify one or more particular tables of the database 112 that contain the desired database information. In some examples, the identifiers may additionally specify particular locations within tables, such as particular fields, where the desired information is stored.

For instance, when the first user starts a session for generating a new REST webservice, they may provide a command for activating the replica data model 114.

This results in the initiation request 111 being sent to the database system 106. In response to receiving the initiation request 111, the processor 108 checks the validity of the database table structure that is stored in the replica data model 114, which is shown schematically in FIG. 1 with data exchange 113. This can be performed by checking the validity of the identifiers that are included in the replica data model 114 against the structure of the database 112 using the data dictionary 128.

If there is any invalid information in the replica data model 114, then the application layer 126 can take remedial action in relation to what is presented to the user on the display 102. For instance, an invalid identifier may be presented to the user, but identified with an error message to inform the user that the identifier is invalid. The invalid identifier may also be presented in such a way that it cannot be selected by a user, and therefore cannot be represented by a subsequent user request 110. It is advantageous to prevent such an invalid user request 110 because (as will be appreciated from the following description) sending an invalid user request 110 to the processor 108 could result in an invalid REST webservice being generated, which would not be allowed by the database system 106.

In this way, validating the database table structure of the replica data model 114 can be performed such that only valid identifiers can be presented to the user for selection. This can result in subsequent user requests 110 not representing any invalid identifiers.

This validation functionality can enable the replica data mode 114 to be provided in a flexible way (such that a user can include the data structure of non-standard tables in the replica data model 114 if required, for example), while still providing some mitigation against invalid REST webservices being generated by the processor 108.

Initially, the user request 110 will be described with reference to a read operation in this disclosure. Although it will be appreciated that write operations are also possible, as discussed further below.

The user can provide a selection to the input 104 section of the web browser 100, which in response provides a user request 110 to the replica data model 114. The user request 110 can represent a selection of one or more identifiers in the database structure. In this way, the web browser 100 queries the replica data model 114. The query 116 is based on, and thereby is representative of, the user request 110.

The replica data model 114 is shown, in this example, as a component or module that is external to the database system 106. In another example, the replica data model 114 could be stored on a user device, such as a device that is used to provide the web browser 100 to the first user.

As indicated above, the replica data model 114 is representative of the structure of the database 112 that ultimately stores the desired database information. The database 112 can store information in tables, in which case the replica data model 114 encodes information about the structure of the tables stored in the database 112. The database table structure that is stored in the replica data model 114 can include information about what tables are stored in the database 112, and can also store information about the internal structure of any table or set of tables within the database 112.

Furthermore, in some examples the replica data model 114 may store information about only a subset of the internal structure of the database 112, and optionally information about only a subset of the internal structure of one or more tables. That is, the subset includes less information than that required to describe the whole database 112. The subset may be 70%, 80% or 90% of the relevant tables that the user would wish to take out of the database 112, for example. This can exclude tables that store control and system information, which may be considered not relevant to a typical user's requirements. Such a subset can be a very small proportion of the entire database. It has been found that such a subset can still provide adequate functionality for many specific applications. Alternatively, a specific subset of the internal structure of the database 112 may be identified as being suitable for a specific purpose. Examples of a specific purpose include for financial management, business management or HR purposes, as non-limiting purposes. Although it will be appreciated that the nature of the content of the database is not important to the teachings of the present disclosure; instead it is the mechanism of providing access to the database information in the database 112 that has been improved.

The replica data model 114 does not need to contain the database information, or any of the content of the database 112. The functionality of the replica data model 114 is directed to representing the structure of the database 112 rather than the content of the database 112. In this way, the replica data model 114 can be said to be independent of the database information or content, because changes to the database information or content do not necessarily result in any changes to the replica data model 114. Changes to the structure of the database 112 can cause corresponding changes to the replica data model 114, such that the replica data model 114 can accurately represent the structure of the database, or a subset of the database, as it changes over time. That is, the replica data model 114 may not include any of, or all of the database information that is stored in the database 112.

It has surprisingly been found that by replicating at least part of the structure of database 112, and storing that structure as a replica data model 114, an efficient and user-friendly system for generating one or more REST webservices can be achieved. This can be because the first user does not need to know the data structure of the database—instead they can navigate to the fields in the database that they want to access using a REST webservice by interacting with the browser 100. This will be discussed in more detail below. Any direct interactions with the database 112 can be very difficult or impossible unless the user is an experienced developer. Therefore, the time required to generate one or more REST webservices can be very significantly reduced. This is both in terms of: (i) the time required by the user; and also (ii) for the database system 106 to perform the necessary processing steps. This can include reducing or avoiding errors in generating the REST webservice, which can be due to the way that the processor 108 generates the REST webservice. For instance, the presentation of information to the user using the display 102 of the web browser 100 can be a lot easier and less prone to errors than known SAP tools.

In some examples, the tables within the database 112 may be standard tables, the structure of which may be specified by the database vendor. In other examples, the tables in the database 112 may be non-standard tables that have been defined or customised by a particular user of the database 112. Such non-standard tables can therefore depart from the structure of standard tables. Use of the replica data model 114 advantageously provides a computationally convenient and efficient mechanism for allowing the first user to generate a REST webservice that can interact with both standard and non-standard tables. This is because the replica data model 114 can be representative of both standard and non-standard tables in the database table structure. Again, this enables the first user to generate a REST webservice for interacting with both standard and non-standard tables without having to access the actual database 112 to determine details of any non-standard tables.

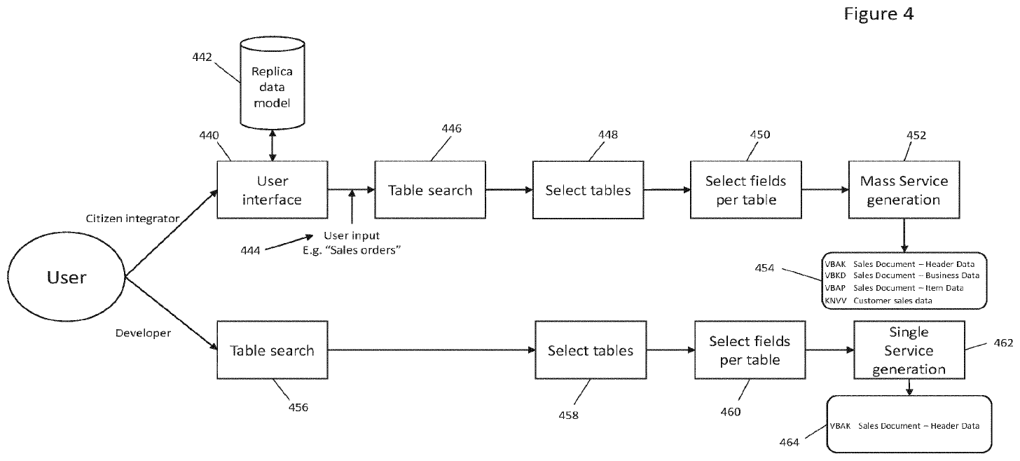

In response to receiving the query 110 from the web browser 100, the replica data model 114 returns one or more identifiers 118 of the requested database information to the web browser 100. The identifiers 118 may specify one or more particular tables of the database 112 that contain the desired database information. In some examples, the identifiers 118 may additionally specify particular locations within tables, such as particular fields, where the desired information is stored. Specific examples of how the system can be used to generate one or more REST webservices will be describe below with reference to FIG. 4 in particular.

In one example, the user request 110 may result in the user being able to make their final selection of the identifiers that they wish to be included in the new REST webservice, in which case they can select those identifiers and click a “generate” button. The web browser 100 can then provide the selected identifiers 119 to the processor 108 such that it can generate one or more new REST (REpresentation State Transfer) webservices 122 using the selected identifiers 119. The one or more new REST webservices 122 can then be stored in a REST webservices storage block 130.

The REST webservices storage block 130 may simply be computer memory associated with the database system 106. In some examples the REST webservices storage block 130 is part of an ICM (Internet Communication Manager), such that the REST webservices can be subsequently called from the ICM. A REST webservice can subsequently be run to interact with the database 112 to provide access to the relevant database information (either for a reading operation or a writing operation).

In other examples, an iterative process of querying the replica data model 114 with progressively more precise information from a series of user requests 110 can be used to determine the selected identifiers 119 for generating the new REST webservice 122. In this way, each user request 110 can provide part of the information required for the user to be able to determine the selected identifiers 119. In such an example, the replica data model 114 may receive a first user request 110 in response to a first UI screen that is shown in the display 102 of the web browser 100. The first UI screen may provide high level details of the tables in the database 112, but not necessarily any fields within those tables. Therefore, the first user request 110 may be a selection of one or more of the tables that are indicated on the first UI screen (but without them clicking a “generate” button). In response, the replica model 114 returns a first set of identifiers 118 of one or more tables, and fields within those tables, to the web browser 100. In response, the web browser 100 updates the display 102 such that it presents a second UI screen to the first user. In this example, the second UI screen is representative of one or more fields within those tables that are denoted by the first set of identifiers 118 (that were selected by the user using the first UI screen). The user can then provide a second user request 110 in response to the second UI screen. Therefore, the second user request 110 may be a selection of one or more of the fields that are indicated on the second UI screen. In response, the replica model 114 returns a second set of identifiers 118 of one or more selected tables and/or fields to the processor 108. The user can then select which of the second set of identifiers 118 they wish to be included in the REST webservice, and then click a “generate” button”. Clicking the “generate” button” causes the web browser 100 to send the selected identifiers 119 to the processor 108 such that it can generate a new REST webservice based on the selected identifiers 119.

It will be appreciated, of course, that there can be any number of sequential user requests 110 before they click the “generate” button to cause the selected identifiers 119 to be sent to the database system 106.

It will be appreciated that such an iterative approach to receiving the user request 110 can advantageously provide a mechanism for the user to navigate through a database structure in order to identify tables and fields that are relevant to an intended purpose.

Again, this can all be achieved without having to access the database 112, which can include vast amounts of data. Directly accessing the database 112 to extract the information that has been recognised as being relevant can be very slow.

In an example where the database system 106 is an SAP system, a user request 110 can be generated in accordance with existing SAP credentials for the user. In this way, the user can only access data that they are authorized to access

Optionally, the replica data model 114 can also store descriptive text associated with one or more of the table or field identifiers. The descriptive text can also be shown to the user on the display 102 of the web browser 100. Without such descriptive text, in some implementations the identifiers themselves may not be intuitively recognisable to the user.

FIG. 1 illustrates an improved way of generating one or more REST webservices that can subsequently be used to read database information from the database 112, or for writing database information into the database 112. The use of the replica data model 114 can be advantageous because it enables a user that does not necessarily have detailed technical database expertise to generate REST webservices for accessing desired information, without writing bespoke computer code. Such a user is sometimes referred to as a citizen integrator/a business user. There is no need to write such bespoke code because the replica data model 114 enables identification of the location within the database 112 where the desired information is to be read (or written), and the processor 108 can automatically generate one or more REST webservices based on the information returned by the replica data model 114.

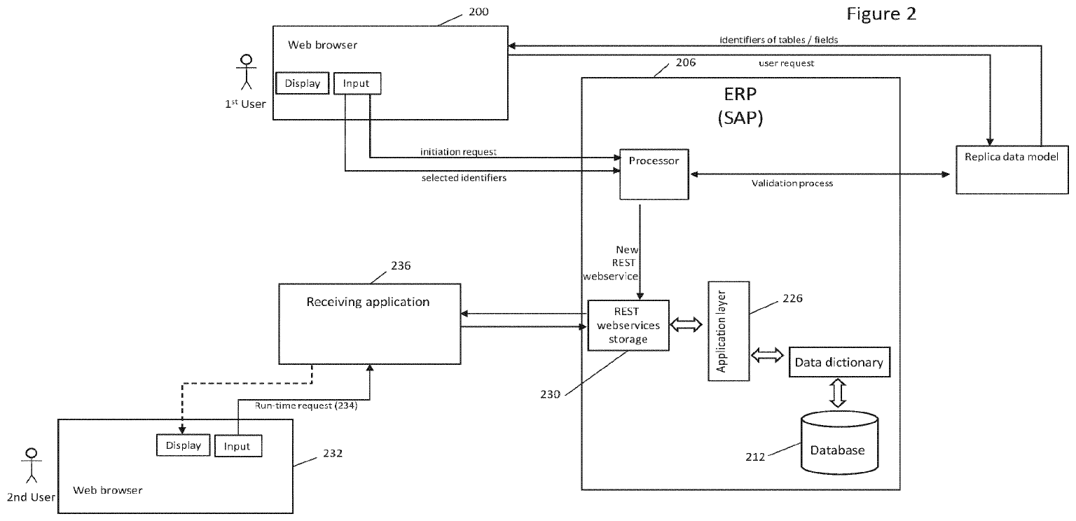

FIG. 2 shows an example of how the computing system of FIG. 1 can be used for accessing information in a database 212, by running one or more REST webservices that were generated by the processing that is described with reference to FIG. 1. Features of FIG. 2 that are also shown in FIG. 1 will be given corresponding reference numbers in the 200 series and will not necessarily be described again here.

In FIG. 2, a web browser 232 associated with a second user is shown as calling a REST webservice that is stored in the REST web storage block 230. It will be appreciated that the second user may or may not be the same person as the first user (associated with the first web browser 200).

The second user provides an instruction to an input region of the web browser 232 to select one or more REST webservices that are available in the REST webservices storage block 230. This causes a runtime request 234 to be sent to a receiving application 236. The runtime request 234 is initiated because the second user wishes to access database information in the database 212 that is associated with the selected one or more REST webservices.

The receiving application 236 can be an external application, an enterprise service bus (ESB), or a message broker as non-limiting examples. The receiving application 236 can also be considered as an integration platform, and is optionally a cloud-based platform. Since the database information will be provided by the REST webservice in an open format, the receiving application 236 can be any standard computing system that does not require proprietary database-specific technology.

The receiving application 236 provides an instruction to the database system 206 such that the one or more selected REST webservices are run. When the database system 206 runs the one or more REST webservices, the REST webservice accesses the database 212 via the application layer 226. The REST webservice then sends the relevant database information back to the receiving application 236.

Use of a REST webservice can advantageously ensure that the database information is provided in an open format, such that it can be accessible to any standard computer system, without requiring complex, database-specific, proprietary technology.

In other examples, the receiving application 236 may provide an instruction to the database system 206 to run one or more REST webservices automatically; that is, not necessarily in response to a user-initiated runtime request 234. For instance, the receiving application 236 may run one or more REST webservices periodically, or in response to one or more automatically generated triggers.

In some examples, the receiving application 236 can then send the relevant database information to one or more receiving systems, which may or may not include the second user's browser 232.

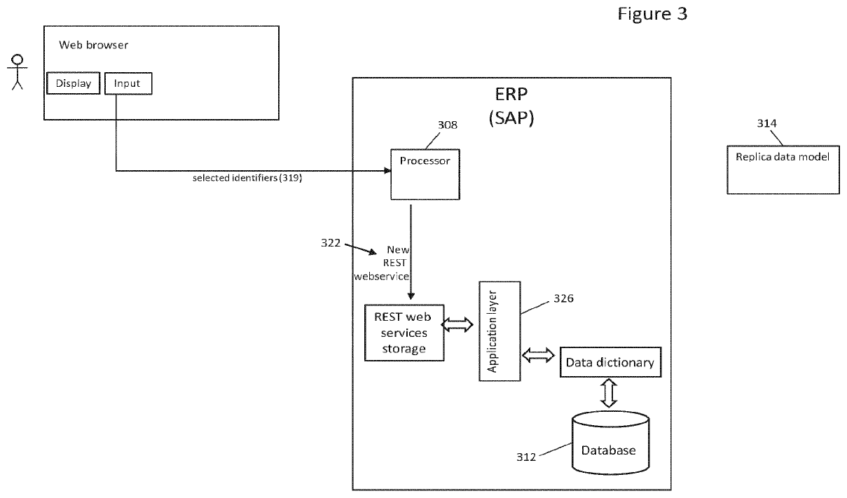

FIG. 3 shows another example of how the computing system of FIG. 1 can be used for enabling access to a database 312, via an application layer 326. Like features have been given like reference numerals in the 300 series and will not necessarily be discussed further here.

In this example, the processor 308 receives one or more selected identifiers 319. Here, the one or more selected identifiers 319 are suitable for handling by the processor 308 for generating a new REST webservice 322 without the need to query the replica data model 314. For instance, this could be because the user is a developer that is familiar with the identifiers of the database structure, and therefore he or she does not need to use the replica data model 314 to navigate through the database structure to find the identifiers that they are looking for. For this reason, the selected identifiers 319 will be referred to as one or more direct-identifier. The direct-identifier can contain information that can directly identify desired database information.

FIG. 4 shows schematically two different ways in which a user can generate a REST webservice using a system described herein. A first way is illustrated by the upper branch of the figure, and can be suitable for a citizen integrator (for example a person who is not an experienced developer). A second way is illustrated by the lower branch of the figure, and can be suitable for a developer with good knowledge of the structure of the database for which they wish to generate a REST webservice.

Considering the citizen integrator user first (the upper branch in the drawing). The user interacts with a user interface 440 (such a web browser as described with reference to FIG. 1), and provides an indication that they wish to generate a REST webservice. This interaction causes the contents of a replica data model 442 to be validated, such that only valid identifiers can be presented to the user for selection. The user interface 440 then presents a display to the user that provides the functionality for the user to select one or more identifiers or tables and/or fields. As shown in FIG. 4 with reference 444, a user provides user input. In this example, the user provides input as a text string, such that a user request is sent to the replica data model 442 so that it is searched for the text string: “Sales orders”. In other examples, the user can initiate a user request by selecting one or more checkboxes that are associated with various aspects of the database table structure that are stored in the replica data model 442.

In response to the user request that relates to “Sales orders”, the system searches the replica data model 442 for tables that are relevant to “Sales orders”. This is represented as the “Table search” step 446 in FIG. 4. In this (heavily simplified) example, the replica data model 442 returns the following table identifiers, which are then displayed to the user:

| | |
|---|---|
| MVKE | Sales Org, distribution channel |
| MLAN | Sales data, tax indicator, tax |
| KNVV | Sales Area Data (terms, order probability) |
| VBAK | Sales Document-Header Data |
| VBKD | Sales Document-Business Data |
| VBAP | Sales Document-Item Data |
| VBEP | Sales Document Schedule Line |
| KNVV | Customer sales data |

As can be seen, descriptive text (e.g. “Sales Org, distribution channel”) can also be displayed with each table identifier (e.g. “MVKE”).

At step 448, the user interacts with the user interface again and selects 4 of the tables—in this example by marking a checkbox associated with the desired tables. This is illustrated below with an X after the selected tables:

| | |
|---|---|
| MVKE | Sales Org, distribution channel |
| MLAN | Sales data, tax indicator, tax |
| KNVV | Sales Area Data (terms, order probability) |
| VBAK | Sales Document-Header Data X |
| VBKD | Sales Document-Business Data X |
| VBAP | Sales Document-Item Data X |
| VBEP | Sales Document Schedule Line |
| KNVV | Customer sales data X |

This causes the user interface to send a second user request to the replica data model 442 that is representative of the selected tables. In response to this second user request, the system searches the replica data model 442 for the identifiers of the fields in the tables that have been selected. In this (heavily simplified) example, the replica data model 442 returns the following field identifiers for the VBAK table (it will be appreciated that field identifiers will similarly be returned for the other selected tables):

| Field | Description | Datatype | Length |
|---|---|---|---|
| MANDT | Client | CLNT | 3 |
| VBELN | Sales Document | CHAR | 10 |
| ERDAT | Date on Which Record Was Created | DATS | 8 |
| ERZET | Entry time | TIMS | 6 |
| ERNAM | Name of Person Created the Object | CHAR | 12 |
| ANGDT | Quotation/Inquiry is valid from | DATS | 8 |
| BNDDT | Date until quotation is binding | DATS | 8 |
| AUDAT | Document Date (Date Received/Sent) | DATS | 8 |

Again, descriptive text (e.g. “Client”) can be displayed with each field identifier (e.g. “MANDT”).

At step 450, the user interacts with the user interface again and selects 5 of the fields for this table. This is illustrated below with an X after the selected fields:

| Field | Description | Datatype | Length |
|---|---|---|---|
| MANDT | Client X | CLNT | 3 |
| VBELN | Sales Document X | CHAR | 10 |
| ERDAT | Date on Which Record Was Created | DATS | 8 |
| ERZET | Entry time X | TIMS | 6 |
| ERNAM | Name of Person Created the Object | CHAR | 12 |
| ANGDT | Quotation/Inquiry is valid from X | DATS | 8 |
| BNDDT | Date until quotation is binding X | DATS | 8 |
| AUDAT | Document Date (Date Received/Sent) | DATS | 8 |

After the user has selected the fields in this table (and fields in any other tables that they wish to be covered by the REST webservice), they can provide an input to the user interface to indicate that they are ready to generate the REST webservice. This causes the user interface to instruct the database system to generate one or more REST webservices based on the identifiers of the selected tables and fields. In this example, this can be considered as mass service generation 452 because more than one (in this example four—one for each of the tables selected) REST webservice is automatically generated. The four REST webservices are illustrated schematically in FIG. 4 with reference 454. In other examples, a single REST webservice can be used to access data information in a plurality of tables.

Now turning to the developer user (the lower branch in the drawing). The user can directly interact with a table search 456 to select tables 458 and fields 460. This time however, the system does not supply a user request to a replica data model because the user does not need to be guided through the database structure visually using the user interface. Instead, the system can simply generate a REST webservice (here a single REST webservice) 462, which is illustrated schematically in FIG. 4 with reference 464.

Systems and methods of the present disclosure can be used to write database information to a database, as well as to read database information from a database. The location for writing database information into the database, in terms of tables and fields, can be defined in the same way as discussed above with reference to reading information by using identifiers. The processor can then configure an appropriate REST webservice to write the relevant database information via the application layer. In some examples, both read and write operations may be combined into a single REST webservice to perform a compound operation to control access to database information on a database. In this way, a REST webservices can be configured to: (i) read the database information via an application layer in communication with the database and provide the database information as an open format message; and/or (ii) write the database information to the database. In some examples, a REST webservice can be configured to write the database information to the database via the application layer.

1. A computer-implemented method for generating one or more REST webservices for providing access to database information in an SAP system, the method comprising:
receiving a user request to interact with the database information;
querying a replica data model based on the user request, wherein the replica data model is representative of a database table structure of a database containing the database information;
returning, in response to the querying, one or more identifiers of the database information based on the user request and the database table structure;
generating one or more REST webservices based on one or more selected identifiers, wherein the REST webservices are configured to:
read the database information via an application layer in communication with the database and provide the database information as an open format message; or
write the database information to the database.

2. The method of claim 1, wherein the replica data model is representative of an internal structure of tables of the database.

3. The method of claim 1, wherein the replica data model is representative of a subset of an internal structure of a table of the database.

4. The method of claim 1, wherein the replica data model is independent of the database information.

5. The method of claim 1, wherein a table of the database represented in the replica data model is a non-standard table.

6. The method of claim 1, wherein the one or more identifiers specify one or more tables of the database and/or one or more fields of one or more tables of the database.

7. The method of claim 1, wherein the user request is generated by an iterative process of interaction between a user and the replica data model.

8. The method of claim 1, further comprising validating the one or more identifiers by communicating the generated REST webservice to the application layer to determine that it is consistent with a structure of the database.

9. The method of claim 1, wherein generating the one or more REST webservices is performed in response to receiving one or more direct-identifiers directly from a user, the one or more direct-identifiers configured to identify database information stored in the database.

10. The method of claim 1, further comprising using the REST webservice to read or write the database information via the application layer.

11. The method of claim 1, further comprising using the REST webservice to provide the database information as the open format message.

12. The method of claim 1, further comprising:
validating the database table structure of the replica data model such that only valid identifiers can be presented to the user for selection, and therefore such that the user request does not represent any invalid identifiers.

13. A computer-readable memory medium comprising code configured to perform the method of claim 1.

14. An apparatus comprising:
a replica data model is representative of a database table structure of a database containing database information in an SAP system;
a user interface configured to:
receive a user request to interact with database information;
query the replica data model based on the user request;
receive, in response to the query, one or more identifiers of the database information based on the user request and the database table structure; and
a processor configured to:
generate one or more REST webservices based on the one or more selected identifiers, wherein the REST webservices are configured to:
read the database information via an application layer in communication with the database and provide the database information as an open format message; or
write the database information to the database.
